(19) United States
(12) Patent Application Publication
(10) Pub. No.: US 2013/0134679 A1
(43) Pub. Date: May 30, 2013

(54) NON-CONTACTING SEAL ARRANGEMENT, ELECTROMECHANICAL SYSTEM HAVING A NON-CONTACTING SEAL ARRANGEMENT, AND METHOD OF FABRICATING A NON-CONTACTING SEAL ARRANGEMENT

(71) Applicant: Praveen Kumar GARLAPATI, Hyderabad (IN)

(72) Inventor: Praveen Kumar GARLAPATI, Hyderabad (IN)

(73) Assignee: GENERAL ELECTRIC COMPANY, Schenectady, NY (US)

(21) Appl. No.: 13/307,260

(22) Filed: Nov. 30, 2011

(51) Int. Cl. F16J 15/16; B23P 11/00; F16J 15/02

(52) U.S. Cl. 277/345; 277/590; 29/428

(57) ABSTRACT

Disclosed is a non-contacting seal arrangement, an electromechanical system having a non-contacting seal arrangement, and a process of fabricating a non-contacting seal arrangement. The non-contacting seal arrangement includes a shape-memory alloy portion, a non-contacting seal, and an ingress gap. The ingress gap is between the non-contacting seal and the shape-memory alloy portion, between a surface of an electromechanical system and the non-contacting seal, or between the surface of the electromechanical system and the shape-memory alloy. An increase in temperature expands the non-contacting seal and the shape-memory alloy portion substantially maintains the ingress gap. The electromechanical system includes a rotating component and a surface extending around at least a portion of the rotating component and forming the ingress gap. The process includes securing the shape-memory alloy portion, securing the non-contacting seal, and forming the ingress gap.

### FIELD OF THE INVENTION

The present invention is directed to electromechanical systems and seals. More specifically, the present invention is directed to non-contacting seals and electromechanical systems having non-contacting seals, and methods of fabricating non-contacting seals.

### BACKGROUND OF THE INVENTION

Motors and other electromechanical systems are repeatedly subjected to ambient temperature variation. Such temperature variation can be difficult on operation of the motors or other electromechanical system and reduce performance of the system. For example, such temperature variation can expand or contract elastic portions within seals of the motor or other electromechanical systems. The expansion or contraction of such portions can cause seals to becoming tighter or looser, in response to a temperature change limiting operational temperature ranges.

In general, motors and components of motors are designed to operate over a predetermined temperature range. Materials for elastic portions are selected to reduce operational concerns based upon expansion or contraction in the predetermined temperature range. Contact seals are affected by tightening or loosening as a response to expansion or contraction from temperature changes. Non-contact seals are affected by gaps being increased or decreased in size, thereby increasing or decreasing ingress of foreign substances. Such increases and decreases modify the overall ingress protection level and consistency of motors and other electromechanical systems. For example, neoprene contracts 0.132 inches per foot in response to an ambient temperature change from 24° C. to −54° C. In addition, neoprene expands 0.274 inches per foot in response to an ambient temperature from 24° C. to 191° C. Such variation results in substantial increasing or decreasing of such seals, thereby limiting the temperature versatility of motors and other electromechanical systems.

Such constraints based upon ambient temperature change result in limitations on versatility for motors and other electromechanical systems. For example, motors designed with neoprene contact seals having dimensions based upon intended operation at a temperature of about −54° C. will have operational limitations when operated at a temperature of about +24° C. At the higher temperature, the neoprene contact seals will wear out quickly (due to friction) or be unable to move. Similarly, motors designed with neoprene contact seals having dimensions based upon intended operation at a temperature of about +24° C. will have operational limitations when operated at a temperature of −54° C. At the lower temperature, the neoprene contact seals will be inadequate at providing a seal.

A seal arrangement, an electromechanical system, and a process of fabricating a seal arrangement that do not suffer from one or more of the above drawbacks would be desirable in the art.

### BRIEF DESCRIPTION OF THE INVENTION

In an exemplary embodiment, a non-contacting seal arrangement includes a shape-memory alloy portion, a non-contacting seal, and an ingress gap. The ingress gap is between the non-contacting seal and the shape-memory alloy portion, between a surface of an electromechanical system and the non-contacting seal, or between the surface of the electromechanical system and the shape-memory alloy. An increase in temperature expands the non-contacting seal and the shape-memory alloy portion substantially maintains the ingress gap.

In another exemplary embodiment, an electromechanical system includes a rotating component and a surface extending around at least a portion of the rotating component and forming an ingress gap. The ingress gap is between a non-contacting seal and a shape-memory alloy portion, between a surface of the electromechanical system and the non-contacting seal, or between the surface of the electromechanical system and the shape-memory alloy. An increase in temperature expands the non-contacting seal and the shape-memory alloy portion substantially maintains the ingress gap.

In another exemplary embodiment, a process of fabricating a non-contacting seal arrangement includes securing a shape-memory alloy portion, securing a non-contacting seal, and forming an ingress gap. The ingress gap is between the non-contacting seal and the shape-memory alloy portion, between a surface of an electromechanical system and the non-contacting seal, or between the surface of the electromechanical system and the shape-memory alloy. An increase in temperature expands the non-contacting seal and the shape-memory alloy portion substantially maintains the ingress gap.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a side partial cutaway schematic view of an exemplary electromechanical system according to the disclosure.

FIG. 2 is a schematic view of an exemplary non-contacting seal arrangement according to the disclosure.

FIG. 3 is a schematic view of an exemplary non-contacting seal arrangement according to the disclosure.

FIG. 4 is a schematic view of an exemplary non-contacting seal arrangement according to the disclosure.

Wherever possible, the same reference numbers will be used throughout the drawings to represent the same parts.

### DETAILED DESCRIPTION OF THE INVENTION

Provided is an exemplary seal arrangement, an electromechanical system, and a process of fabricating a seal arrangement. Embodiments of the present disclosure permit increased operational efficiency in electromechanical systems having non-contacting seals in comparison to known systems, permit increased resistance to damage from foreign objects and liquids in non-contacting seals in comparison to known seals, permit an ingress gap to be maintained at a predetermined width in ingress regions of non-contacting seal arrangements, provide versatility in temperature operation for electromechanical systems having non-contacting seals, and combinations thereof.

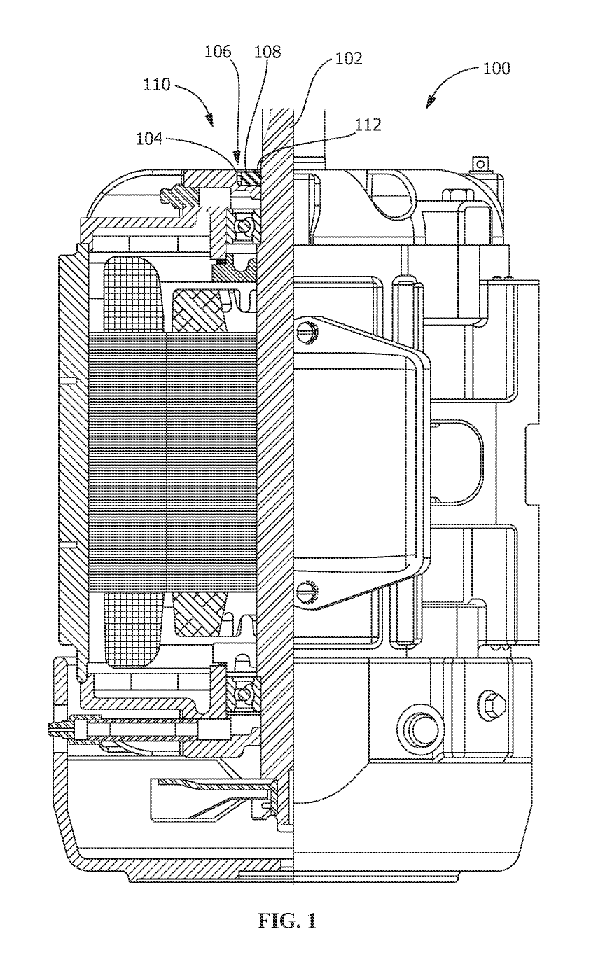

FIG. 1 shows an exemplary electromechanical system 100. The system 100 is any suitable motor, turbine, compressor, other suitable electromechanical system, or any suitable combination thereof. For example, in one embodiment, the system 100 is an electric motor (not shown). In a further embodiment, the electric motor includes a rotating part (such as a rotor), a stator, a shaft supported on a bearing system, and end shields at each end along with a fan and fan cover.

The system 100 includes a rotating component 102. The rotating component 102 is any suitable rotating portion of the system 100 in direct or indirect communication with a sealed or partially sealed portion of the system 100. For example, in one embodiment, the rotating component 102 is an electric motor shaft proximal to an electrical motor ingress portion.

A surface 104 extends around at least a portion of the rotating component 102. In one embodiment, the surface 104 extends circumferentially around the rotating component 102. In this embodiment, the surface 104 forms a cylindrical housing containing the rotating component 102 or a portion of the rotating component 102. In another embodiment, the surface 104 does not completely extend around the rotating component 102. For example, in one embodiment, the surface 104 extends tangential to the rotating component 102 and/or one or more additional surfaces enclose the rotating component 102 in conjunction with the surface 104.

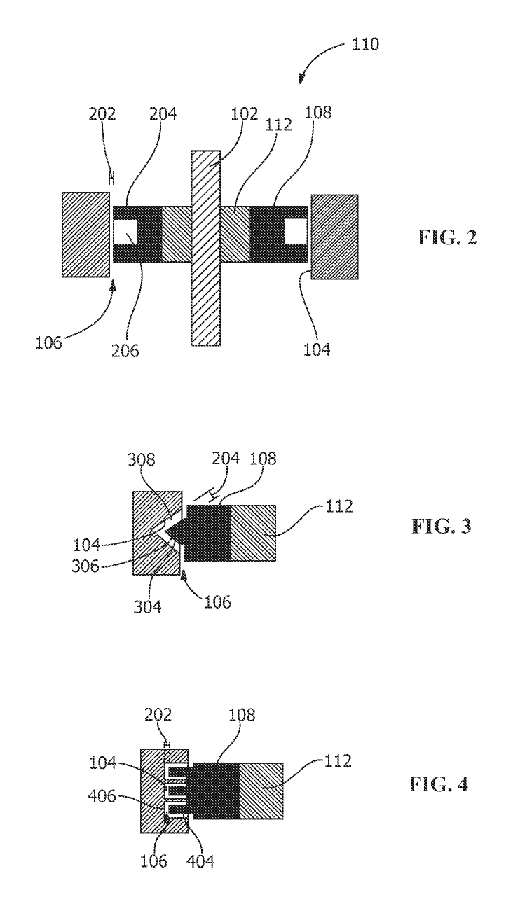

In one embodiment, a region within the surface 104 and/or the one or more additional surfaces (not shown) is an ingress gap 106. In one embodiment, the ingress gap 106 is positioned with a non-contacting seal 108 opposite the surface 104 and/or the one or more additional surfaces. In one embodiment, the ingress gap 106 has a predetermined width 202 (based upon the distance between the surface 104 and the non-contacting seal 108) as is shown in FIGS. 2-4.

The non-contacting seal 108 is a portion of a non-contacting seal arrangement 110. The non-contacting seal arrangement 110 includes the non-contacting seal 108 and a shape-memory alloy portion 112 arranged and disposed to form the ingress gap 106. In one embodiment, the non-contacting seal 108 is secured to the rotating component 102. In one embodiment, the shape-memory alloy portion 112 is secured to the rotating component 102. In one embodiment, the non-contacting seal 108 is secured to the surface 104. In one embodiment, the shape-memory alloy portion 112 is secured to the surface 104. In further embodiments, the non-contacting seal 108 and the shape-memory alloy portion 112 are secured to each other, more than one non-contacting seal 108 is included, more than one shape-memory alloy portion 112 is included, or combinations thereof.

The non-contacting seal 108 is any suitable seal material. In one embodiment, the non-contacting seal 108 includes an elastic material. Exemplary elastic materials include, but are not limited to, nitrile, neoprene (also known as polychloroprene), fluorocarbon elastomer, ethylene propylene, silicone, low-temperature type silicone fluorosilicone, or combinations thereof. In one embodiment, the elastic material is selected by a coefficient of thermal expansion and/or based upon an amount of contraction and/or expansion over a predetermined temperature range. For example, in one embodiment, the coefficient of thermal expansion is about 6.2×10⁻⁵ in./in./° F. (as in nitrile), 7.6×10⁻⁵ in./in./° F. (as in neoprene), 9.0×10⁻⁵ in./in./° F. (as in flurocarbon elastomer), 8.3×10⁻⁵ in./in./° F. (as in ethylene propylene), 1.0×10⁻⁴ in./in./° F. (as in silicone), 1.1×10⁻⁴ in./in./° F. (as in low-temperature type silicone fluorosilicone), or within a range, such as, between 6.0×10⁻⁵ in./in./° F. and 1.0×10⁻⁴ in./in./° F., between 7.0×10⁻⁵ in./in./° F. and 9.0×10⁻⁵ in./in./° F., between 7.0×10⁻⁵ in./in./° F. and 8.0×10⁻⁵ in./in./° F., between 7.2×10⁻⁵ in./in./° F. and 7.8×10⁻⁵ in./in./° F., any combination or sub-combination thereof, or any other suitable range based upon the properties of the elastic materials disclosed herein.

In one embodiment, the elastic material and the shape-memory alloy portion 112 correspond such that an increase in temperature expands the non-contacting seal 108 and controls the expansion of the shape-memory alloy portion 112 to a desired level thereby maintaining the ingress gap 106, generally, maintaining substantially consistent dimensions. Additionally or alternatively, the elastic material and the shape-memory alloy portion 112 correspond such that a decrease in temperature maintains the contraction of the non-contacting seal 108 and expands the shape-memory alloy portion 112 to a desired level thereby maintaining the ingress gap 106, generally, maintaining substantially consistent dimensions. In one embodiment, the corresponding relationship between the elastic material and the shape-memory alloy portion 112 substantially maintains the predetermined width 202 of the ingress gap 106.

Referring to FIG. 2, in one embodiment, the predetermined width 202 of the ingress gap 106 is based upon a distance between a substantially planar geometry of the non-contacting seal 108 and the surface 104 of the system 100 (see FIG. 1). In this embodiment, the non-contacting seal 108 includes a plurality of protrusions 204 extending toward the surface 104 and forming a recessed portion 206. Each of the plurality of the protrusions 204 maintains a substantially equal distance from the surface 104 during temperature changes within a predetermined operational temperature range.

Referring to FIG. 3, in one embodiment, the predetermined width 202 of the ingress gap 106 is based upon a distance between a substantially triangular geometry of the non-contacting seal 108 and the surface 104 of the system 100 (see FIG. 1). In this embodiment, the non-contacting seal 108 includes an angled protrusion 304 extending toward the surface 104 along two tangential surfaces 306. The angled protrusion 304 maintains a substantially equal distance between the tangential surfaces 306 and the surface 104 during temperature changes within a predetermined operational temperature range. In this embodiment, the surface 104 of the system 100 includes a recess 308 having a substantially triangular geometry corresponding to the angled portions 304 and the tangential surfaces 306.

Referring to FIG. 4, in one embodiment, the predetermined width 202 of the ingress gap 106 is based upon a distance between a complex geometry of the non-contacting seal 108 and the surface 104 of the system 100 (see FIG. 1). In this embodiment, the non-contacting seal 108 includes protrusions 404 extending toward the surface 104 into corresponding recesses 406 of the surface 104. The protrusion 404 maintains a substantially equal distance between the recesses 406 and/or the surface 104 during temperature changes within a predetermined operational temperature range. In one embodiment, the recesses 406 each have a rectangular geometry corresponding to the protrusions 404.

The predetermined operational temperature range is any suitable temperature range where the materials selected in the non-contacting seal arrangement 110 are capable of maintaining the predetermined width 202 of the ingress gap 106 within a predetermined range. In one embodiment, the predetermined width 202 is maintained within a range of between about 0.2 mm and about 0.5 mm over a range of −40° C. and +50° C., within a range of between about 0.3 mm and about 0.5 mm over a range of −40° C. and +0° C., within a range of between about 0.2 mm and about 0.5 mm over a range of 0° C. and +50° C., within a range of between about 0.25 mm and about 0.5 mm over a range of −20° C. and +20° C., or any suitable combination or sub-combination thereof.

The maintaining of the predetermined width 202 in the non-contacting seal arrangement 110 provides protection from environmental contaminates that is greater than known non-contacting seal arrangements. As will be appreciated by those skilled in the art, ingress protection ratings or IP ratings describe protection against solid objects and/or protection against liquids. Generally, IP ratings are listed with a first digit corresponding to the protection from solid objects and a second digit corresponding to the protection against liquids. The scale for the protection against solid objects is as follows: 0 refers to being non-protected, 1 refers to being protected against solid objects greater than 50 mm (e.g., a large surface of the body such as the hand—no protection against deliberate access) and/or solid objects exceeding 50 mm diameter, 2 refers to being protected against solid objects greater than 12 mm diameter and other objects not exceeding 80 mm in length, 3 refers to being protected against solid objects (e.g., tools, wires, etc.) greater than 2.5 mm diameter, 4 refers to being protected against solid objects greater than 1.0 mm diameter, 5 refers to being protected from dust (ingress of dust is not totally prevented but does not enter in sufficient quantity to interfere with satisfactory operation of the equipment), 6 refers to being dust tight (no ingress of dust).

The scale for protection from liquid is as follows: 0 refers to being non-protected, 1 refers to being protected against dripping water (vertically falling drops), 2 refers to being protected against dripping water when tilted to 15° (vertically dripping water shall have no harmful effect), 3 refers to being protected against spraying water (water falling as spray at an angle of up to 60° from the vertical shall have no harmful effect), 4 refers to being protected against splashing water (water splashed against the enclosure from any direction shall have no harmful effect when the enclosure is tiled at any angle up to 15° from its normal position), 5 refers to being protected against water jets (water protected from a nozzle against the enclosure from any direction shall have no harmful effect), 6 refers to being protected against heavy seas (water from heavy seas or water projected in powerful jets shall not enter the enclosure in harmful quantities, 7 refers to being protected against the effects of immersion (ingress of water in harmful quantity shall not be possible when the enclosure is immersed in water under defined conditions of pressure and time), 8 refers to being protected against submersion (the equipment is suitable for continuous submersion in water under manufacturer-identified conditions), and 9K refers to being protected against close-range high pressure spray downs under high temperature (the water pressure is between 1160 and 1450 psi at a rate of about 4 gallons per minute and a temperature of 176° F. from a nozzle between 4 and 6 inches long).

In one embodiment, the non-contacting seal arrangement 110 includes an ingress protection rating against solid objects identifying that the non-contacting seal arrangement 110 protects against dust and shows no deposits of harmful material during operation (for example, an ingress protection or IP rating of “5”). In one embodiment, the non-contacting seal arrangement 110 includes an ingress protection rating against liquids identifying that the non-contacting seal arrangement 110 protects against rain falling at up to 60° from the vertical (for example, an IP rating of “3”), the non-contacting seal arrangement 110 protects against water splashes directly from all directions (for example, an IP rating of “4”), or the non-contacting seal arrangement 110 protects against jets of water from all directions (for example, an IP rating of “5”). In one embodiment, the non-contacting seal arrangement 110 includes an ingress protection rating against dust and shows no deposits of harmful material during operation and against jets of water from all directions (for example, an IP rating of “55”). In a further embodiment, the non-contacting seal arrangement 110 maintains the ingress protection rating throughout the operational temperature range (for example, between about −40° C. and about +50° C.). In one embodiment, the non-contacting seal arrangement 110 includes an ingress protection rating indicating that it is dust tight and protected against heavy seas (for example, an IP rating of “66”). In some embodiments, the IP rating is greater than 55, greater than 56, or greater than 65.

The shape-memory alloy portion 112 is any suitable material capable of maintaining the predetermined width 202 of the ingress gap 106 with the non-contacting seal 108. The shape-memory alloy portion 112 exhibits shape memory properties and behaves similar to a spring. The shape memory properties are reversible solid state transformations based upon composition, structure, flexural modulus properties, and other suitable properties. Exemplary materials for the shape-memory alloy portion 112 include, but are not limited to, nickel-titanium alloys, copper-zinc-aluminum alloys, copper-aluminum-nickel alloys, silver-cadmium alloys, gold-cadmium alloys, copper-tin alloys, copper-zinc alloys, indium-titanium alloys, nickel-aluminum alloys, iron-platinum alloys, manganese-copper alloys, iron-manganese-silicon alloys, other suitable alloys, or suitable combinations thereof.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A non-contacting seal arrangement, comprising:
a shape-memory alloy portion;
a non-contacting seal; and
an ingress gap between the non-contacting seal and the shape-memory alloy portion, between a surface of an electromechanical system and the non-contacting seal, or between the surface of the electromechanical system and the shape-memory alloy;
wherein an increase in temperature expands the non-contacting seal and the shape-memory alloy portion substantially maintains the ingress gap.

2. The non-contacting seal arrangement of claim 1, wherein the shape-memory alloy portion is secured to a rotating component of the electromechanical system.

3. The non-contacting seal arrangement of claim 1, wherein the shape-memory alloy portion is secured to a stationary component of the electromechanical system.

4. The non-contacting seal arrangement of claim 1, wherein the non-contacting seal includes an elastic material.

5. The non-contacting seal arrangement of claim 1, wherein the non-contacting seal includes a material selected from the group consisting of nitrile, neoprene, fluorocarbon elastomer, ethylene propylene, silicone, low-temperature type silicone fluorosilicone, and combinations thereof.

6. The non-contacting seal arrangement of claim 1, wherein the ingress gap includes a substantially planar geometry.

7. The non-contacting seal arrangement of claim 1, wherein the ingress gap includes a substantially triangular geometry.

8. The non-contacting seal arrangement of claim 1, wherein the ingress gap includes a recess.

9. The non-contacting seal arrangement of claim 1, wherein the non-contacting seal includes a plurality of protrusions extending toward the surface.

10. The non-contacting seal arrangement of claim 1, wherein the non-contacting seal includes an angled protrusion extending toward the surface.

11. The non-contacting seal arrangement of claim 1, wherein the ingress gap includes a plurality of recesses and the non-contacting seal includes a plurality of corresponding protrusions.

12. The non-contacting seal arrangement of claim 1, wherein the substantial maintaining of the ingress gap is over a predetermined temperature range, the predetermined temperature range being selected from the group consisting of −40° C. and +50° C., −40° C. and +0° C., 0° C. and +50° C., and −20° C. and +20° C.

13. The non-contacting seal arrangement of claim 1, wherein the substantial maintaining of the ingress gap is over a predetermined distance range of between about 0.2 mm and about 0.5 mm, between about 0.25 mm and about 0.5 mm, or between about 0.3 mm and about 0.5 mm.

14. The non-contacting seal arrangement of claim 1, wherein the non-contacting seal arrangement includes an ingress protection rating against solid objects identifying that the non-contacting seal arrangement protects against dust and shows no deposits of harmful material during operation.

15. The non-contacting seal arrangement of claim 1, wherein the non-contacting seal arrangement includes an ingress protection rating against liquids identifying that the non-contacting seal arrangement protects against rain falling at up to 60° from the vertical, against water splashes directly from all directions, against jets of water from all directions, or a combination thereof.

16. The non-contacting seal arrangement of claim 1, wherein includes an ingress protection rating against solids indicating that it is dust tight.

17. The non-contacting seal arrangement of claim 1, wherein includes an ingress protection rating against liquids indicating that it is protected against heavy seas.

18. The non-contacting seal arrangement of claim 1, wherein the shape-memory alloy portion includes material selected from the group consisting of a nickel-titanium alloy, a copper-zinc-aluminum alloy, a copper-aluminum-nickel alloy, a silver-cadmium alloy, a gold-cadmium alloy, a copper-tin alloy, a copper-zinc alloy, an indium-titanium alloy, a nickel-aluminum alloy, an iron-platinum alloy, a manganese-copper alloy, an iron-manganese-silicon alloy, and combinations thereof.

19. An electromechanical system, comprising:
a rotating component; and
a surface extending around at least a portion of the rotating component and forming an ingress gap;
wherein the ingress gap is between a non-contacting seal and a shape-memory alloy portion, between a surface of the electromechanical system and the non-contacting seal, or between the surface of the electromechanical system and the shape-memory alloy;
wherein an increase in temperature expands the non-contacting seal and the shape-memory alloy portion substantially maintains the ingress gap.

20. A process of fabricating a non-contacting seal arrangement, the process comprising:
securing a shape-memory alloy portion;
securing a non-contacting seal; and
forming an ingress gap, the ingress gap being between the non-contacting seal and the shape-memory alloy portion, between a surface of an electromechanical system and the non-contacting seal, or between the surface of the electromechanical system and the shape-memory alloy;
wherein an increase in temperature expands the non-contacting seal and the shape-memory alloy portion substantially maintains the ingress gap.
